(19) United States
(12) Patent Application Publication
(10) Pub. No.: US 2016/0201938 A1
(43) Pub. Date: Jul. 14, 2016

(54) RECESSED AIR CHUTE DESIGN

(71) Applicant: Hyundai Translead, San Diego, CA (US)

(72) Inventor: Younghag Choi, Chula Vista, CA (US)

(21) Appl. No.: 14/597,140

(22) Filed: Jan. 14, 2015

(51) Int. Cl. F24F 13/02; B60H 1/00; B60P 3/20

(52) U.S. Cl. CPC F24F 13/0254; B60P 3/20; B60H 1/00014

(57) ABSTRACT

System and apparatus for channeling air through a cargo space including: a front section including at least one front opening; a rear section including at least one rear opening; and at least one channel coupling the front section to the rear section, the at least one channel recessed into a ceiling of the cargo space, the at least one channel configured to receive and channel air blown into the at least one front opening through the at least one rear opening into the cargo space.

### BACKGROUND

1. Field of the Invention

The present invention relates to a system for channeling air through a cargo space, and more specifically, to a recessed air chute system.

2. Background

Refrigerated trucks, trailers, containers, railcars, and various other types of cargo space have utilized a type of chute to channel the cold air from the blower section of a refrigeration unit to the cargo space to be cooled. Such refrigerated cargo space includes a refrigeration unit and connected blower unit to which one end of the chute is connected. The other end of the chute is open to the cargo space. These chutes are made of a textile material, e.g., canvas, cotton or similar material such as vinyl. These fabrics chutes are suspended from the ceiling or wall portion of the cargo space by snap fasteners or the like. These chutes extend approximately two-thirds of the length of the refrigerated cargo space. As these fabric chutes are flexible and suspended from the ceiling, they assume a semi-circular or catenary shape with reference to the ceiling of the cargo space.

### SUMMARY

The present invention provides for channeling air through a cargo space.

In one implementation, a recessed air chute system for a cargo space is disclosed. The system includes: a front section including at least one front opening; a rear section including at least one rear opening; and at least one channel coupling the front section to the rear section, the at least one channel recessed into a ceiling of the cargo space, the at least one channel configured to receive and channel air blown into the at least one front opening through the at least one rear opening into the cargo space.

In another implementation, an apparatus for channeling air through a cargo space is disclosed. The apparatus includes: means for providing at least one front opening; means for providing at least one rear opening; and means for recessing at least one channel into a ceiling of the cargo space, the means for recessing configured to receive and channel air blown into the means for providing at least one front opening through the means for providing at least one rear opening and into the cargo space.

Other features and advantages of the present invention should be apparent from the present description which illustrates, by way of example, aspects of the invention.

### BRIEF DESCRIPTION OF THE DRAWINGS

The details of the present invention, both as to its structure and operation, may be gleaned in part by study of the appended further drawings, in which like reference numerals refer to like parts, and in which:

FIG. 1A is a bottom perspective view of a front section of conventional chutes connected to the blower section of a refrigeration unit for a cargo space;

FIG. 1B is a bottom perspective view of a rear section of the conventional chutes for a cargo space;

FIG. 2A is a bottom perspective view of a front section of a recessed air chute system in accordance with one embodiment of the present disclosure;

FIG. 2B is a front view of the recessed air chute system showing the channels that are recessed into the ceiling of the cargo space;

FIG. 2C is a bottom perspective view of a rear section of the recessed air chute system in accordance with one embodiment of the present disclosure;

FIG. 2D is a rear view of the recessed air chute system showing the channels that are recessed into the ceiling of the cargo space;

FIG. 3 is a rear view of a refrigerated truck or trailer including the recessed air chute system in accordance with one embodiment of the present disclosure;

FIG. 4 is a rear view of a refrigerated truck or trailer including a recessed air chute system in accordance with another embodiment of the present disclosure.

### DETAILED DESCRIPTION

As stated above, refrigerated trucks, trailers, containers, railcars, and various other types of cargo space have utilized a type of hanging vinyl chute to channel the cold air from the blower section of a refrigeration unit to the cargo space to be cooled. Such refrigerated cargo space includes a refrigeration unit and connected blower unit to which one end of the chute is connected. The other end of the chute is open to the cargo space. The disadvantages of such hanging chutes include constantly being subjected to damage during loading due to the loading equipment and/or the load tearing the chute. Another problem which has been observed with such chutes is that when the cargo load is stacked too high within the cargo space, the stacked load further tends to push the flexible or non-rigid chute against the top of the cargo space, thus creating a blockage of air which prohibits proper refrigeration of the load within the cargo space.

To address the above-stated disadvantages and problems using a hanging vinyl chute to channel the cold air from the blower section of a refrigeration unit to the cargo space, several embodiments of a recessed air chute design are proposed. In one embodiment, the recessed air chute includes channels built into the ceiling of the cargo space. After reading this description it will become apparent how to implement the invention in various implementations and applications. However, although various implementations of the present invention will be described herein, it is understood that these implementations are presented by way of example only, and not limitation. As such, this detailed description of various implementations should not be construed to limit the scope or breadth of the present invention.

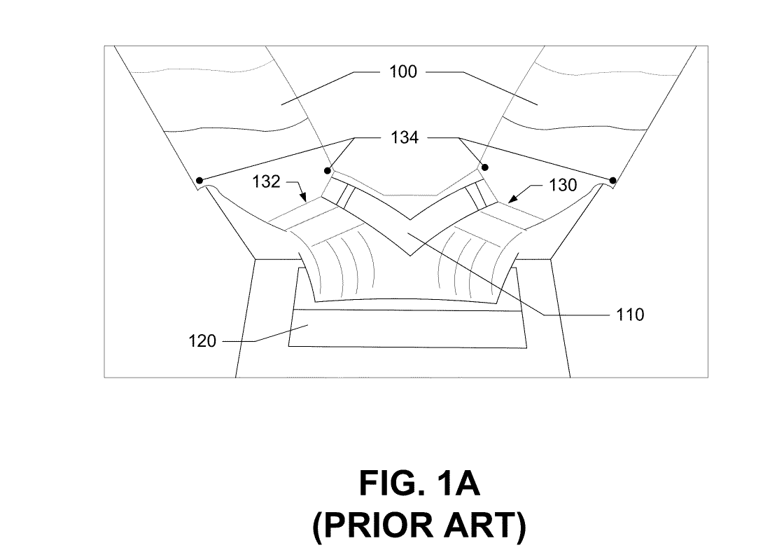

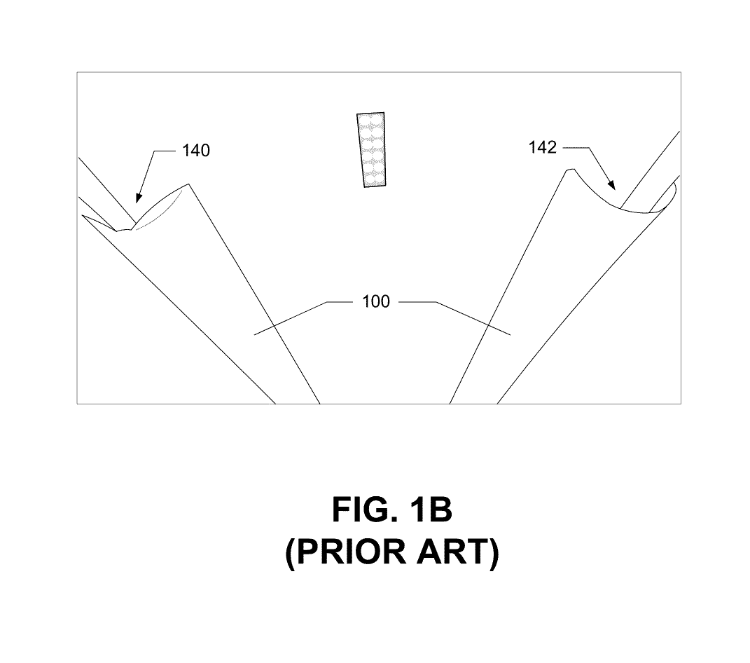

FIG. 1A is a bottom perspective view of a front section of conventional chutes 100 connected to the blower section 110 of a refrigeration unit 120 for a cargo space. FIG. 1A shows the conventional chutes 100 configured as hanging vinyl chutes to channel the cold air from the blower section 110 of a refrigeration unit 120 to the cargo space to be cooled. As shown, the blower unit 110 connects to the front section of the chutes 100 at connection points 130, 132. The rear section of the chutes are open to the cargo space (shown in FIG. 1B). These chutes are made of a textile material, e.g., canvas, cotton or similar material such as vinyl. As stated above, these fabrics chutes are suspended from the ceiling or wall portion of the cargo space by snap fasteners 134.

FIG. 1B is a bottom perspective view of a rear section of the conventional chutes 100 for a cargo space. FIG. 1B shows the rear section of the conventional chutes 100 which are open 140, 142 to the cargo space. These chutes extend approximately two-thirds of the length of the refrigerated cargo space. As these fabric chutes 100 are flexible and suspended from the ceiling, they assume a semi-circular shape with reference to the ceiling of the cargo space.

As noted above, the disadvantages of such chutes include constantly being subjected to damage during loading due to the loading equipment and/or the load tearing the chute. Also during the operation of the refrigeration unit, some cool, moist air is constantly being channeled through the fabric chute. This causes the chute to become damp and moist. This moisture and dampness is conducive to bacterial growth and the formation of slime along the inner surfaces of the chute. Thus, when such chutes become contaminated, the air passing through also becomes contaminated and is circulated throughout the entire cargo area. This condition adversely affects the cargo contained within the refrigerated space. Moreover, because of the cost and labor involved in removing the chutes for cleaning, chutes are rarely cleaned. In the event they are cleaned, the chutes are subjected to rot due to moisture and the inability of the fabric chute to be fully dried. Further, when the cargo load is stacked very high within the cargo space, the stacked load further tends to push the flexible or non-rigid chute against the top of the cargo space, thus creating a blockage of air which prohibits proper refrigeration of the load within the cargo space.

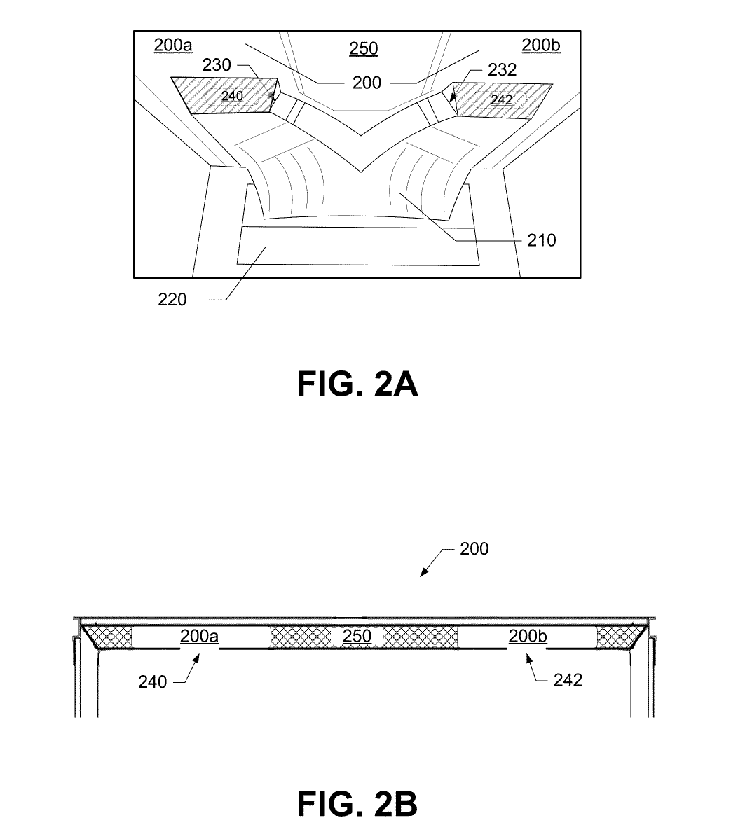

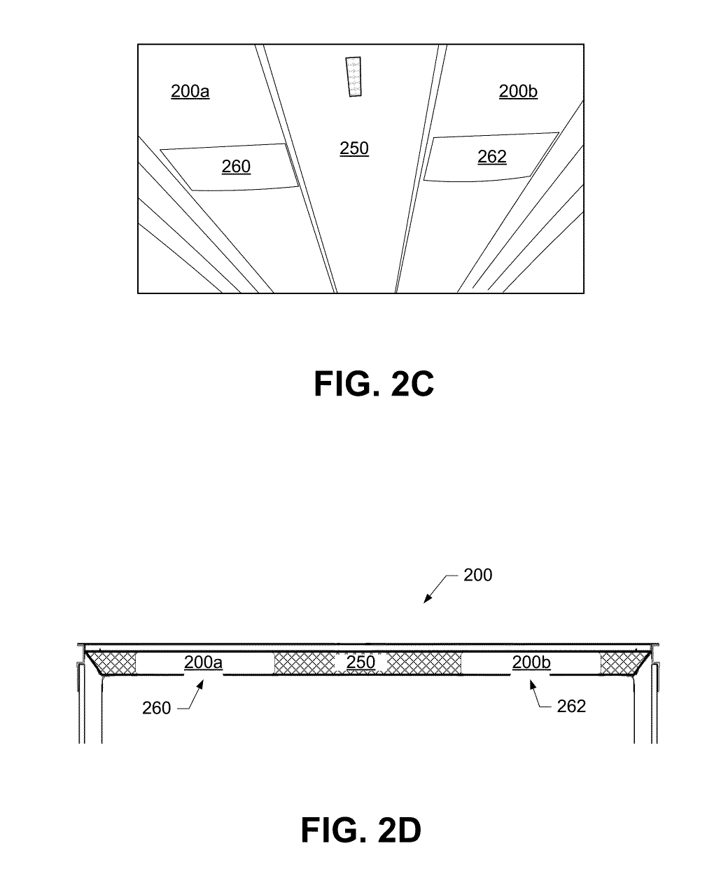

FIG. 2A is a bottom perspective view of a front section of a recessed air chute system 200 in accordance with one embodiment of the present disclosure. In the illustrated embodiment of FIG. 2A, the recessed air chute system 200 is built into the ceiling of the cargo space and includes two channels 200a, 200b. The recessed air chute system 200 connects to the blower section 210 of a refrigeration unit 220 through front openings 240, 242 at the front section of the recessed air chute system 200. Thus, the blower section 210 blows cold air into the openings 240, 242 of the front section of the two channels 200a, 200b at connection points 230, 232. In other embodiments, the recessed air chute system 200 includes at least one channel to direct or channel the cold air from the front section to the rear section.

FIG. 2B is a front view of the recessed air chute system 200 showing the channels 200a, 200b that are recessed into the ceiling 250 of the cargo space. FIG. 2B also shows the front openings 240, 242 into which the blower section 210 of the refrigeration unit 220 blows cold air. Typically, the thickness of a ceiling of the cargo space is configured to be in the range of about 2-4 inches. With the recessed air chute system (e.g., system 200) built into the ceiling 250 of the cargo space, the thickness of the ceiling is increased. However, in other embodiments, the thickness of the ceiling can be increased or decreased to any appropriate size or even remain the same. Therefore, with the recessed air chute system 200 built into the ceiling 250 of the cargo space, most of the disadvantages of the conventional chutes (e.g., the vinyl air chute system 100 of FIG. 1A) should be eliminated.

FIG. 2C is a bottom perspective view of a rear section of the recessed air chute system 200 in accordance with one embodiment of the present disclosure. FIG. 2C shows the rear view of the recessed air chute system 200 having two channels 200a, 200b built into the ceiling 250 and having rear openings 260, 262. The cold air blown into the front openings 240, 242 by the blower section 210 is passed through the channels 200a, 200b and out into the cargo space through the rear openings 260, 262. Although the illustrated embodiment of FIG. 2C only shows two rear openings 260, 262, in other embodiments, the cold air can be circulated through the cargo space through multiple openings (i.e., three or more openings).

FIG. 2D is a rear view of the recessed air chute system 200 showing the channels 200a, 200b that are recessed into the ceiling 250 of the cargo space. FIG. 2D also shows the rear openings 260, 262 through which the cold air blown into the front openings 240, 242 by the blower section 210 is passed through the channels 200a, 200b and out into the cargo space.

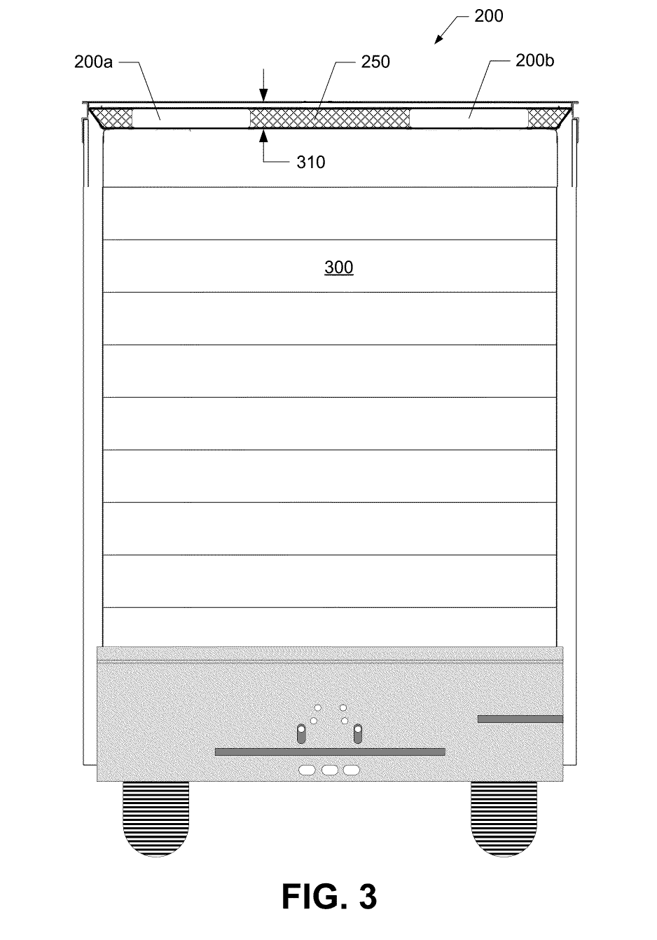

FIG. 3 is a rear view of a refrigerated truck or trailer 300 including the recessed air chute system 200 in accordance with one embodiment of the present disclosure. In other embodiments, the recessed air chute system 200 can be configured for other cargo space such as containers and railcars. In the illustrated embodiment of FIG. 3, the recessed air chute system 200 is built into the ceiling 250 of the cargo space to address the disadvantages of the conventional chutes (e.g., the vinyl air chute system 100 of FIG. 1A). Further, the ceiling 250 includes two channels 200a, 200b.

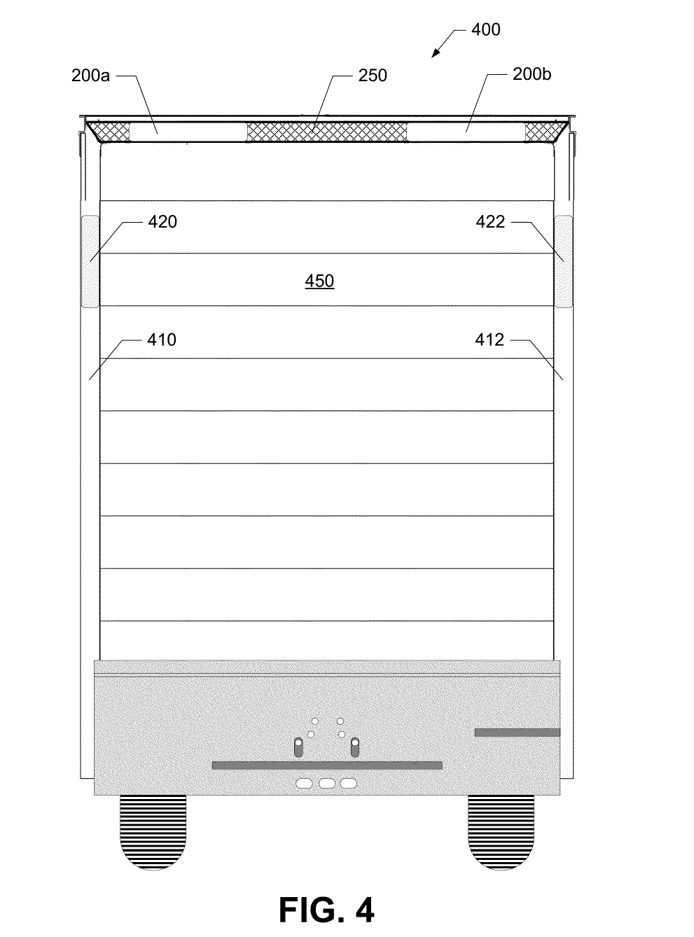

FIG. 4 is a rear view of a refrigerated truck or trailer 450 including a recessed air chute system 400 in accordance with another embodiment of the present disclosure. In the illustrated embodiment of FIG. 4, the recessed air chute system 400 is built into the ceiling 250 and/or the side walls 410, 412 of the cargo space. Thus, in one embodiment of the recessed air chute system 400, air channels 200a, 200b are built into the ceiling 250. In another embodiment of the recessed air chute system 400, air channels 420, 422 are built into the side walls 410, 412, respectively. In yet another embodiment of the recessed air chute system 400, air channels 200a, 200b, 420, 422 are built into the ceiling 250 and the side walls 410, 412. As stated above for the ceiling, the thickness of the side walls 410, 412 of the cargo space which includes the recessed air chute system 400 may need to be increased as well.

With the improved air chute design of the recessed air chute system 200 or 400 shown in FIGS. 2A-2D, 3 and 4, there is significant improvement in the air flow rate. For example, in one comparison test between the vinyl air chutes and the recessed channel chutes, the air flow rate increased from 0.9888 ft³/sec for the vinyl chutes to 11.27 ft³/sec for the recessed chutes. Other advantages of the recess air chute system 200 or 400 include clean design with no possible freight snag points and less maintenance costs.

The above description of the disclosed implementations is provided to enable any person skilled in the art to make or use the invention. Various modifications to these implementations will be readily apparent to those skilled in the art, and the generic principles described herein can be applied to other embodiments without departing from the spirit or scope of the invention. For example, while the embodiments above focus on embedding the recessed air chute system into the ceiling and/or the side walls, the systems can be embedded into other areas of the cargo space such as a floor or front wall. Thus, it is to be understood that the description and drawings presented herein represent a presently preferred embodiment of the invention and are therefore representative of the subject matter that is broadly contemplated by the present invention. It is further understood that the scope of the present invention fully encompasses other embodiments that may become obvious to those skilled in the art and that the scope of the present invention is accordingly limited by nothing other than the appended claims.

1. A recessed air chute system for a cargo space comprising:
a front section including at least one front opening;
a rear section including at least one rear opening; and
at least one channel coupling the front section to the rear section, the at least one channel recessed into a ceiling of the cargo space, the at least one channel configured to receive and channel air blown into the at least one front opening through the at least one rear opening into the cargo space.

2. The system of claim 1, wherein the at least one front opening couples to a blower section of a refrigeration unit.

3. The system of claim 1, wherein the cargo space comprises one of a refrigerated truck, container, or railcar.

4. The system of claim 1, wherein the at least one channel comprises
a pair of recessed channels, each recessed channel built into one side of the ceiling of the cargo space.

5. The system of claim 1, wherein a thickness of the ceiling of the cargo space is increased to accommodate the recessed air chute system.

6. An apparatus for channeling air through a cargo space, the apparatus comprising:
means for providing at least one front opening;
means for providing at least one rear opening; and
means for recessing at least one channel into a ceiling of the cargo space, the means for recessing configured to receive and channel air blown into the means for providing at least one front opening through the means for providing at least one rear opening and into the cargo space.

7. The apparatus of claim 6, wherein the means for providing at least one front opening couples to a blower section of a refrigeration unit.

8. The apparatus of claim 6, wherein the cargo space comprises one of a refrigerated truck, container, or railcar.

9. The apparatus of claim 6, wherein the at least one channel comprises
a pair of recessed channels, each recessed channel built into one side of the ceiling of the cargo space.

10. The apparatus of claim 6, wherein a thickness of the ceiling of the cargo space is increased to accommodate the apparatus for channeling air through a cargo space.
